(19) United States
(12) Patent Application Publication
(10) Pub. No.: US 2007/0268174 A1
(43) Pub. Date: Nov. 22, 2007

(54) JAMMING SIGNAL DETECTOR

(75) Inventors: Christopher V. Ham, Las Cruces, NM (US); Troy E. Scoughton, Las Cruces, NM (US)

Correspondence Address: PEACOCK MYERS, P.C., 201 THIRD STREET, N.W., SUITE 1340, ALBUQUERQUE, NM, 87102, US

(73) Assignee: TMC Design Corporation, Las Cruces, NM (US)

(21) Appl. No.: 11/688,220

(22) Filed: Mar. 19, 2007

Related U.S. Application Data
(60) Provisional application No. 60/783,514, filed on Mar. 17, 2006.

(51) Int. Cl. H04B 7/185

(52) U.S. Cl. 342/17; 342/177; 342/357.12; 342/52

(57) ABSTRACT

The present invention relates to an apparatus and a method for detecting and displaying the existence of a jamming signal. An antenna receives a signal on a predetermined frequency, and an amplifier receives and amplifies the signal from the antenna. A microprocessor determines the existence and magnitude of the jamming signal related to the predetermined frequency and processes an output to a display device to display the existence of the jamming signal to a user.

### CROSS-REFERENCE TO RELATED APPLICATIONS

This application claims priority to and the benefit of the filing of U.S. Provisional Patent Application Ser. No. 60/783,514, entitled “GPS Signal Jamming Detector”, filed on Mar. 17, 2006, and the specification thereof is incorporated herein by reference.

### BACKGROUND OF THE INVENTION

1. Field of the Invention (Technical Field)

The present invention relates to an apparatus and method which provides notification when global positioning system (GPS) signals are being jammed. Particularly, the present invention relates to a small and mobile apparatus which can be worn by a user and which either flashes, vibrates, provides an audible or visible indication, or combinations thereof, when it detects a jamming signal.

2. Description of Related Art

Loss of a GPS signal is becoming an ever increasing problem for users, that must be addressed. People are becoming more and more dependent upon equipment that directly or indirectly utilizes time and/or position from the GPS constellation. Either unintentional interference caused by increased use of the radio frequency (RF) spectrum or intentional jamming has resulted in many reported cases where the ability to use a GPS signal has been denied or significantly degraded. Typically, the user realizes that his/her GPS is not operating properly at some critical moment when either, time, location or direction is needed to perform a mission.

There is thus a present need for a compact, GPS personal protection system, that when utilized, provides instant warning that the GPS systems will either be degraded or rendered useless and thereby provide the user with GPS space situation awareness.

### BRIEF SUMMARY OF THE INVENTION

The present invention relates to an apparatus and a method for detecting and displaying the existence of a jamming signal and includes an antenna operable to receive at least one signal on at least one predetermined frequency, at least one amplifier for receiving and amplifying the signal from the antenna, and a microprocessor operable to receive the amplified signal and determine the existence and magnitude of the jamming signal related to the at least one predetermined frequency and process an output to a display device to display the existence of the jamming signal to a user of the apparatus.

The apparatus in accordance with the present invention detects (GPS) jamming signals with the use of a sensitive receiver that is optimized to detect and measure interference at both GPS frequencies L1 and L2, or at other predetermined frequencies. Furthermore, with the use of a directional antenna, the present invention preferably gives an indication as to the direction of the interference, thus providing crucial intelligence to the user which can be used in determining a course of action.

The antenna, amplifier, microprocessor and display device are preferably disposed in a single housing. This housing may be sized to fit in a human hand or pocket.

The at least one predetermined frequency may be a GPS frequency, and comprise L1 and L2 frequencies. A diplexer may be used to split the amplified signal into L1 and L2 signals. The display device may use LEDs and/or an LCDs for visual output. The display device may vibrate. The display device may be an audio device. Combinations of “displays” (visible, audio and/or vibration) may be used. The type of display of the display device may be selected by the user.

The antenna may be a directional antenna operable to detect a direction of the jamming signal and transmit the direction to the microprocessor for subsequent display on the display device. A converter may be used for receiving the amplified signal and converting the amplified signal into a digital signal for subsequent transmission to the microprocessor. The microprocessor compares the amplified signal with a predetermined value in at least one lookup table to determine if the jamming signal is present and to determine a magnitude of the jamming signal.

The display device provides an alarm that varies in relation to the magnitude of the jamming signal. The display device may provide a plurality of alarms in relation to the magnitude of the jamming signal. For example, the plurality of alarms may include at least two of the following claims: an audio alarm, a vibration alarm, and a visual alarm. The display device may indicate interference magnitude in steps.

The microprocessor performs an initialization function and samples the amplified signal prior to determining the existence and magnitude of the jamming signal related to the at least one predetermined frequency and processes an output to the display device to display the existence of the jamming signal.

A delay loop may be used prior to the microprocessor processing an output to the display device to display the existence of the jamming signal. A repeat loop may be used wherein the microprocessor obtains a sample of the amplified signal at predetermined intervals to determine the existence and magnitude of the jamming signal related to the at least one predetermined frequency and processes an output to the display device to display the existence of the jamming signal.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more preferred embodiments of the invention and are not to be construed as limiting the invention. In the drawings:

FIG. 1 is a perspective view of a housing of the apparatus of the present invention;

FIG. 2 is a schematic diagram of a detection, amplification, diplexing circuit of the apparatus of present invention;

FIG. 2a is a schematic diagram of a down converter circuit of the present invention;

FIG. 3 is a schematic diagram of a converting, comparison, and indicia-creating circuit of the present invention; and

FIG. 4 is a flowchart showing steps of a method in accordance with the present invention.

### DETAILED DESCRIPTION OF THE INVENTION

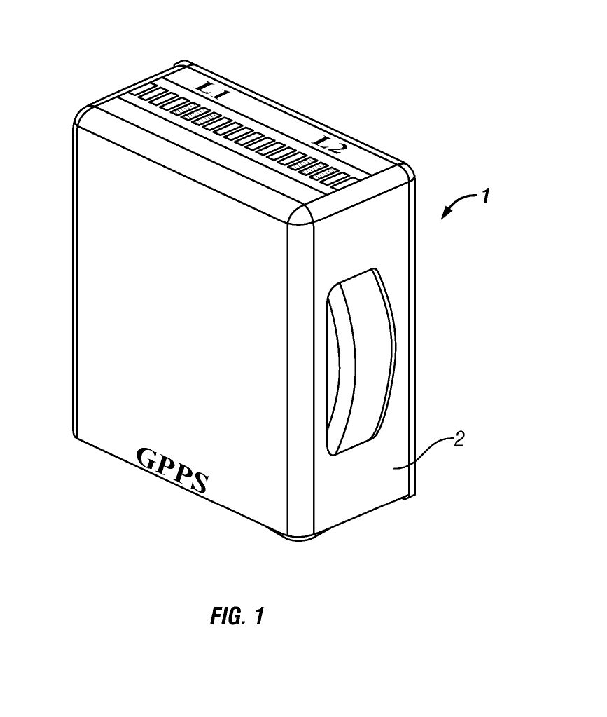

There is shown in FIG. 1 an apparatus for detecting and displaying the existence of a GPS jamming signal in accordance with the present invention and is indicated generally at 1. Apparatus 1 of the present invention includes housing 2 that is sized to be grasped by a human hand and preferably about half of the size of a cigarette pack or similar size to be portable for the user of apparatus 1.

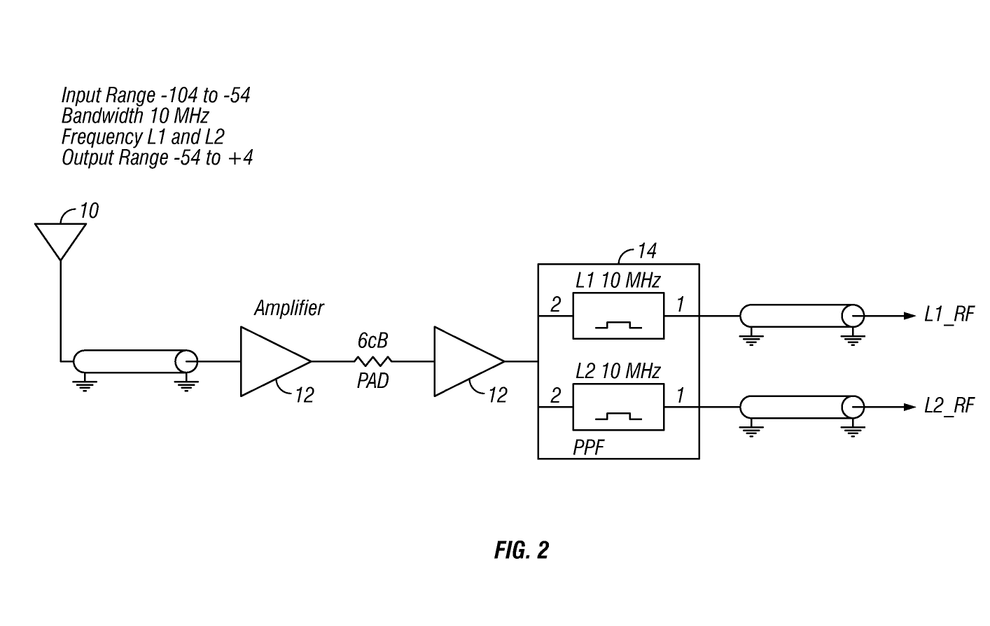

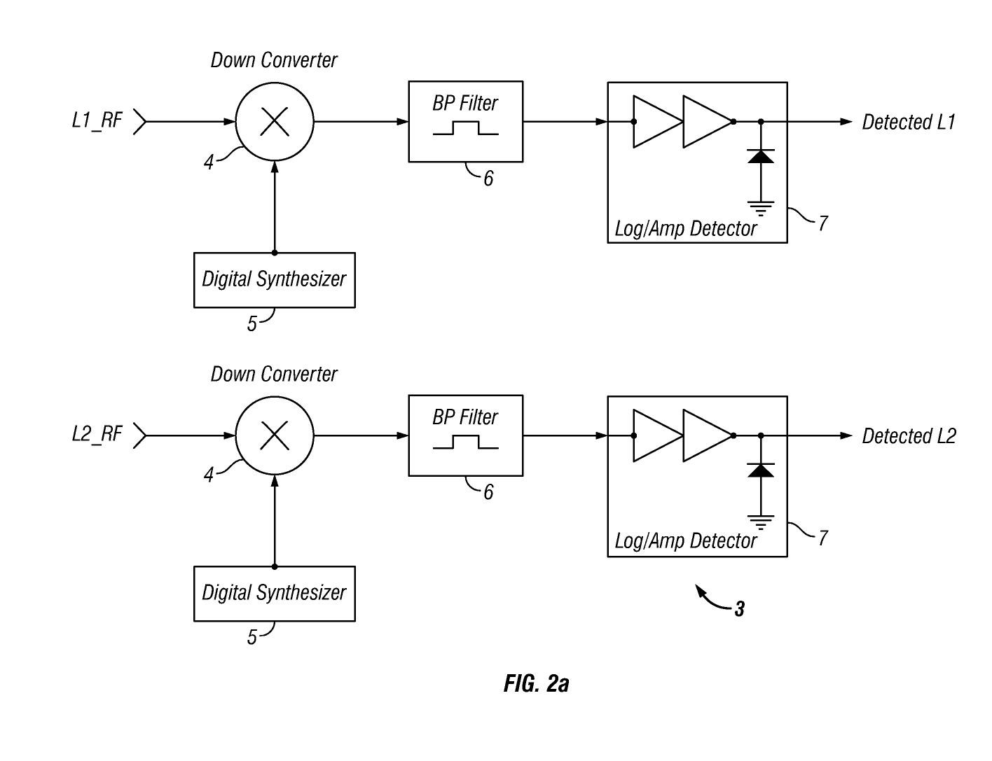

Referring now to FIG. 2, antenna 10 preferably receives signals on predetermined frequencies, such as GPS signals which are in both military and commercial (L1 and L2) frequency bands. Alternatively, antenna 10 may receive signals on other predetermined frequencies. The signals are then amplified through one or more amplifiers 12 before being separated into individual L1 and L2 bands by diplexer 14. In an alternative embodiment, antenna 10 is a directional antenna, such as a Yagi antenna or the like. Directional antenna 10 is preferably used such that the user of apparatus 1 is provided with an indication of the direction from which the jamming signal is originating from and thus provides the user with information allowing the user to seek out and destroy the jamming equipment. Alternatively, apparatus 1 utilizes antenna 10 and an additional directional antenna, while remaining within the scope of the present invention.

Referring now to FIG. 2a, the individual L1 and L2 bands output of diplexer 14 are each preferably routed to down converter circuit 3 comprising, in series, down converters 4, digital synthesizers 5, band pass (BP) filters 6, and log/amp detectors 7 in order to reduce the radio frequency of signals L1 and L2 to an intermediate frequency that apparatus 1 can more easily manage in detecting and displaying the existence of a jamming signal, as will be appreciated by those skilled in the art.

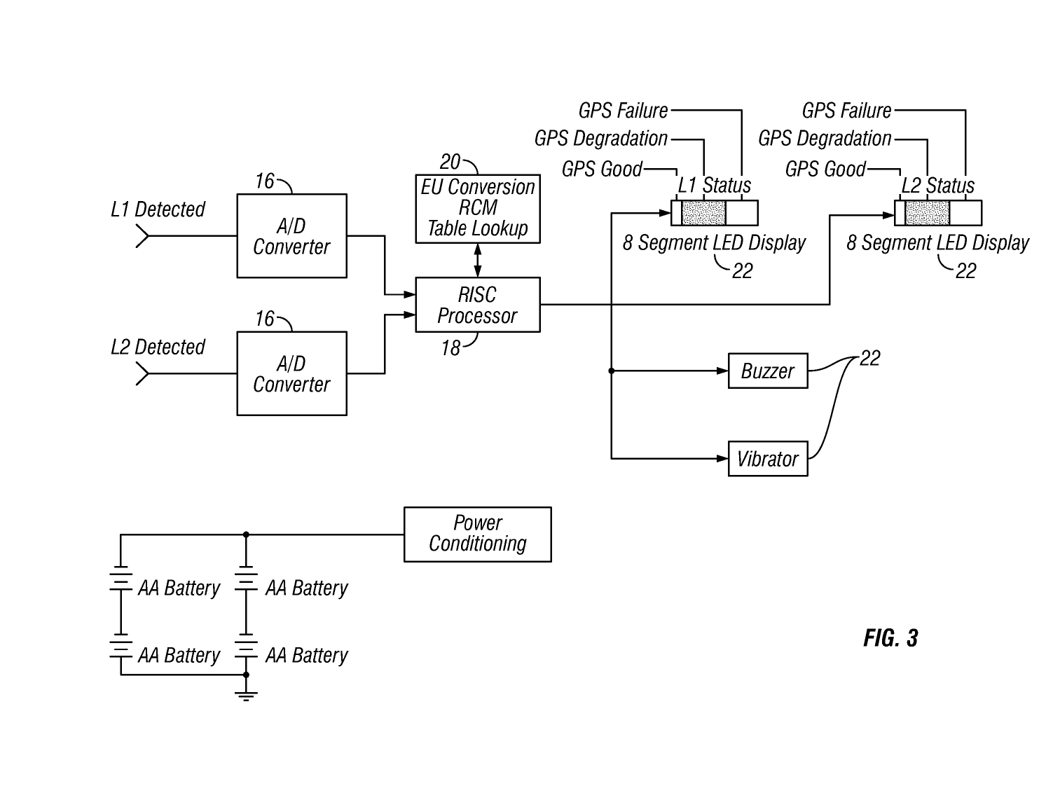

Referring now to FIG. 3, separated signals L1 and L2 are then passed through analog to digital converters 16. After converting each band of the GPS signal into digital signals, those digital signals are processed by microcontroller 18 which preferably refers to values which are stored in external lookup table 20. Upon detecting a jamming signal on one or both bands of the GPS, discussed in more detail below, one or more display devices or indicators 22 are activated by microcontroller 18. Display devices or indicators 22 are preferably a one of, or combinations of, a vibration device, an audio device, and a visual device such as, but not limited to a liquid crystal display (LCD) or light emitting diodes (LEDs). Antenna 10, amplifiers 12, diplexer 14, digital converters 16, microcontroller 18, lookup table 20 and indicators 22 of apparatus 1 are each preferably disposed within housing 2. Alternatively, antenna 10 extends beyond an external surface of housing 2 for improved reception.

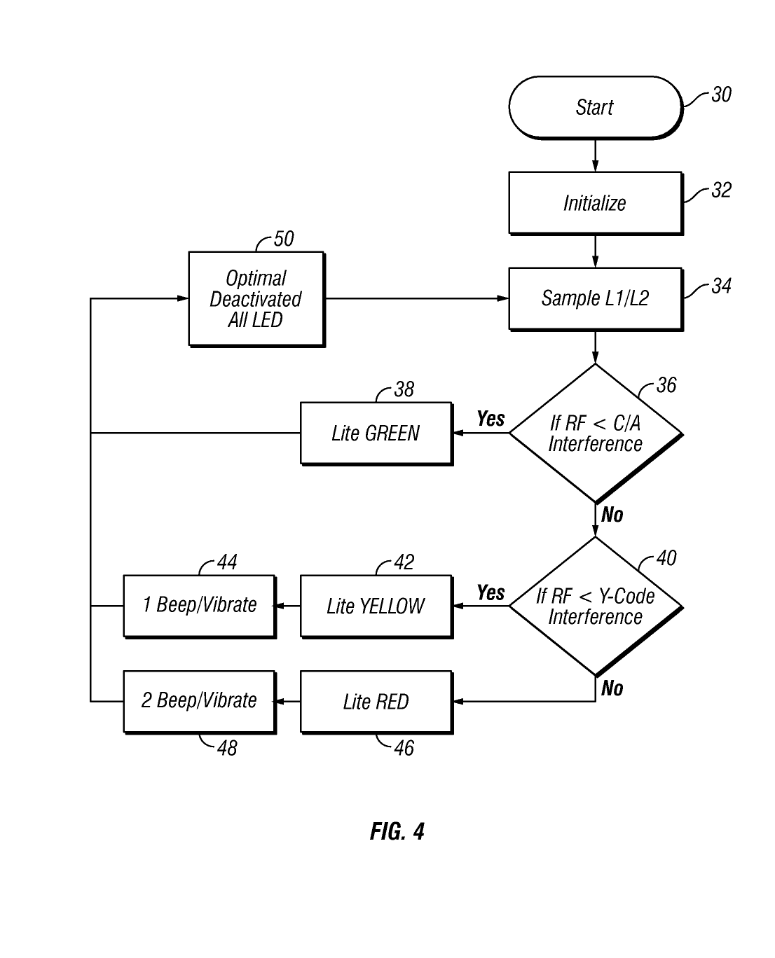

FIG. 4 is a flowchart illustrating steps in accordance with a method of the present invention, indicated generally at 29, such as code for microcontroller 18. Upon startup 30, microcontroller 18 preferably performs initialization function 32. Samples of digital signals for each band of L1 and L2 are preferably taken 34. After samples 34 are taken by microcontroller 18, each digital signal is then preferably compared to reference value 36 which represents a cut-off point of the acceptable magnitude of interference of the L1 (the commercial GPS band), such as by comparing to values in external lookup table 20 in FIG. 3. If the magnitude of interference is less than the reference value for the commercial band, a green light emitting diode (LED) is preferably illuminated 38 and method 29 returns to step 34 where new samples are then taken. If however, the magnitude of interference of the interference is greater than the reference value the microcontroller then performs comparison 40 in which the measured value of L1 and L2 are compared to a second reference value which is preferably greater than the first reference value, such as by comparing to values in external lookup table 20 in FIG. 3. If the magnitude of interference is found to be less than this second reference value, microcontroller 18 then preferably causes display device 22 to issue an alarm, such as by causing a yellow LED to become illuminated 42 and further issuing an audible warning and activates a vibrator in a step 44. Although not shown in FIG. 4, a delay loop can then issued by microcontroller 18 prior to microcontroller 18 returning to step 34 obtain new samples for L1 and L2, such that apparatus I is not constantly beeping and vibrating, as will be appreciated by those skilled in the art.

If, however, the magnitude of the interference in the step 40 is found to be greater than the second reference value, microcontroller 18 then preferably causes display device 22 to issue an alarm, such as by activating a red LED in a step 46 and initiating a plurality of beeps and vibrations in a step 48 before obtaining new samples for L1 and L2 in the step 34. Although not shown in FIG. 4, a delay is optionally provided after the plurality of beeps and vibrations 48 such that the apparatus 1 of the present invention does not become a constant annoyance.

Preferably, output of display device or devices 22 is varied in relation to the magnitude of interference determined in the steps 36 or 40. In an embodiment, indication of three different levels of interference are provided using either a vibrator similar to a cell phone, a bar graph display, or by sound using a speaker or an ear piece, and are preferably user selectable, such as by a switch or the like (not shown) on housing 2 of apparatus 1. For example, in one embodiment, when GPS interference is not detected, the unit does not vibrate or make a sound. When GPS interference is detected that will degrade GPS reception, display device or devices 22 vibrates or chirps one or more times and can optionally repeat at some pre-determined interval, such as every five minutes. In another embodiment, when GPS interference is detected that can jam commercial receivers (C/A code) display device or devices 22 vibrates or chirps twice, then repeats the vibration or chirp at a pre-determined time. In another embodiment, when GPS interference is detected that can jam military receivers (Y-Code), display device or devices 22 vibrates and/or chirps three times and then repeats at some pre-determined time. Those skilled in the art will appreciate that any type or combination of alarms, warnings, or other indication from display devices 22 may be provided to the user of apparatus 1 while remaining within the scope of the present invention. The term “display” is intended to cover visible, audible and/or mechanical (e.g. vibrations) alerts or indications.

In an embodiment, when in a display mode, an LED or LCD display 22 preferably indicates interference magnitude or levels in steps, such as in 6 dB steps from −100 dBm to −40 dBm. Color is preferably used to indicate the GPS environment. For example, green indicates good GPS reception; yellow indicates interference levels that can jam commercial receivers and red indicates interference levels that are high enough to jam military receivers.

Alternatively, all LEDs (or other display devices or indicators 22) are deactivated in step 50 just before microcontroller 18 obtains new samples of L1 and L2 34 such that a maximum of only one LED (or other display device or indicator 22) is illuminated at any given instant.

Although the use of LEDs and/or LCDs is described throughout this application, it is understood that numerous visual indications can be used and to provide desirable results. The housing 2 of apparatus 1 of the present invention is preferably sized small enough to fit into a sleeve or breast pocket and preferably weighs only a few ounces or less. Apparatus 1 of the present invention can also be attached to a vehicle (not shown), including dash boards or the like, by any suitable fastener known to those skilled in the art. In this manner, occupants of the vehicle having the apparatus I disposed therein can be instantly made aware of GPS jamming signals. In a manner similar to a pager or the like, apparatus 1 advantageously alerts the user of the existence of a jamming signal by vibrating, chirping through a speaker or an earpiece, by providing a visual indication on a bar-graph style LCD or LEDs or by other suitable visual display apparatus.

The present invention addresses the need for space situation awareness, defensive counter space, and the need to improve the capability of collecting data relating to radio frequency (RF) events that directly affects a user of the apparatus 1.

### EXAMPLE

In an embodiment, the design specifications of the present invention preferably include:

| | |
|---|---|
| Frequency of Operation: | L1 (1.57542 GHz) and L2 (1.2276 GHz) |
| Minimum Detect Level: | −100 dBm |
| Dynamic Range: | 60 dB |
| Bandwidth of each channel: | 10 MHz |
| Indication of Interference: | 3 Levels |
| Size & Power: | (approx size of cigarette pack) |
| Power: | AA Batteries |

Those skilled in the art will readily recognize that numerous aspects of these specifications can be altered and desirable results will still be produced.

Although the invention has been described in detail with particular reference to these preferred embodiments, other embodiments can achieve the same results. Variations and modifications of the present invention will be obvious to those skilled in the art and it is intended to cover all such modifications and equivalents. The entire disclosures of all references, applications, patents, and publications cited above and/or in the attachments, and of the corresponding application(s), are hereby incorporated by reference.

What is claimed is:

1. An apparatus for detecting and displaying the existence of a jamming signal, comprising:
an antenna operable to receive at least one signal on at least one predetermined frequency;
at least one amplifier for receiving and amplifying said signal from said antenna;
a microprocessor operable to receive said amplified signal and determine the existence and magnitude of the jamming signal related to said at least one predetermined frequency and process an output to a display device to display the existence of the jamming signal to a user of said apparatus.

2. The apparatus of claim 1 wherein said antenna, said at least one amplifier, said microprocessor and said at least one display device are disposed in a housing.

3. The apparatus of claim 2 wherein said housing is sized to fit in a human hand.

4. The apparatus of claim 2 wherein said housing is sized to fit in a pocket.

5. The apparatus of claim 1 wherein said at least one predetermined frequency is a GPS frequency.

6. The apparatus of claim 5 wherein said GPS frequency comprises L1 and L2 frequencies.

7. The apparatus of claim 6 further comprising at least one diplexer operable to split said amplified signal into L1 and L2 signals.

8. The apparatus of claim 1 wherein said display device is at least one of an LED and an LCD display device.

9. The apparatus of claim 1 wherein said display device is a vibration device.

10. The apparatus of claim 1 wherein said display device is an audio device.

11. The apparatus of claim 1 wherein a type of display of said display device is selectable by a user of said apparatus.

12. The apparatus of claim 1 wherein said antenna is a directional antenna operable to detect a direction of the jamming signal and transmit said direction to said processor for subsequent display on said display device.

13. The apparatus of claim 1 further comprising a directional antenna operable to detect a direction of the jamming signal and transmit said direction to said processor for subsequent display on said display device.

14. The apparatus of claim 1 further comprising a converter for receiving said amplified signal and converting said amplified signal into a digital signal for subsequent transmission to said microprocessor.

15. The apparatus of claim 1 wherein said microprocessor compares said amplified signal with a predetermined value in at least one lookup table to determine if the jamming signal is present and to determine a magnitude of the jamming signal.

16. The apparatus of claim 1 wherein said display device provides an alarm that varies in relation to the magnitude of the jamming signal.

17. The apparatus of claim 16 wherein said display device provides a plurality of alarms in relation to the magnitude of the jamming signal.

18. The apparatus of claim 17 wherein said plurality of alarms includes at least two alarms selected from the group consisting of an audio alarm, a vibration alarm, and a visual alarm.

19. The apparatus of claim 13 wherein said display device indicates interference magnitude in steps.

20. A method for detecting and displaying the existence of a jamming signal comprising:
receiving at least one signal on at least one predetermined frequency by an antenna;
amplifying the signal from the antenna with an amplifier;
determining the existence and magnitude of the jamming signal from the amplified signal related to the at least one predetermined frequency using a microprocessor; and
processing an output to a display device to display the existence of the jamming signal.

21. The method of claim 20 comprising disposing the antenna, the at least one amplifier, the microprocessor and the at least one display device in a housing.

22. The method of claim 21 wherein the housing is sized to fit in a human hand.

23. The method of claim 21 wherein the housing is sized to fit in a pocket.

24. The method of claim 20 wherein the at least one predetermined frequency is a GPS frequency.

25. The method of claim 24 wherein the GPS frequency comprises L1 and L2 frequencies.

26. The method of claim 25 further comprising splitting the amplified signal into L1 and L2 signals with a diplexer.

27. The method of claim 20 comprising lighting the display device as the output with at least one of an LED and an LCD.

28. The method of claim 20 comprising vibrating the display device as the output.

29. The method of claim 20 comprising generating an audio output to the display device.

30. The method of claim 20 further comprising a user selecting a type of display of the display device.

31. The method of claim 20 comprising:
detecting a direction of the jamming signal;
transmitting the direction to the microprocessor; and
subsequently displaying the direction on the display device.

32. The method of claim 20 further comprising receiving the amplified signal and converting the amplified signal into a digital signal for subsequent transmission to the microprocessor.

33. The method of claim 20 further comprising comparing the amplified signal with a predetermined value in at least one lookup table to determine if the jamming signal is present and to determine a magnitude of the jamming signal.

34. The method of claim 20 further comprising varying an alarm in relation to a magnitude of the jamming signal.

35. The method of claim 34 further comprising providing a plurality of alarms in relation to the magnitude of the jamming signal.

36. The method of claim 35 wherein the plurality of alarms includes at least two alarms selected from the group consisting of an audio alarm, a vibration alarm, and a visual alarm.

37. The method of claim 20 wherein the display device indicates interference magnitude in steps.

38. The method of claim 20 wherein the microprocessor performs an initialization function and samples the amplified signal prior to determining the existence and magnitude of the jamming signal related to the at least one predetermined frequency and processes an output to the display device to display the existence of the jamming signal.

39. The method of claim 20 further comprising a delay loop prior to the microprocessor processing an output to the display device to display the existence of the jamming signal.

40. The method of claim 20 further comprising a repeat loop wherein the microprocessor obtains a sample of the amplified signal at predetermined intervals to determine the existence and magnitude of the jamming signal related to the at least one predetermined frequency and processes an output to the display device to display the existence of the jamming signal.
